(19) United States
(12) Patent Application Publication
(10) Pub. No.: US 2015/0006266 A1
(43) Pub. Date: Jan. 1, 2015

(54) ELECTRONIC DEVICE AND METHOD FOR BROADCASTING ADVERTISEMENTS ON THE ELECTRONIC DEVICE

(71) Applicants: HON HAI PRECISION INDUSTRY CO., LTD., New Taipei (TW); HONG FU JIN PRECISION INDUSTRY (WUHAN) CO., LTD., Wuhan (CN)

(72) Inventors: HUNG-CHI HUANG, New Taipei (TW); CHING-JOU CHEN, New Taipei (TW)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/972,897

(22) Filed: Aug. 21, 2013

(30) Foreign Application Priority Data
Jun. 27, 2013 (TW) 102123082

(51) Int. Cl. G09F 19/00; G06Q 30/02

(52) U.S. Cl. CPC G09F 19/00; G06Q 30/0241
USPC 705/14.4

(57) ABSTRACT

In a method for broadcasting advertisements on an electronic device, an advertisement currently being broadcasted on an electronic billboard is identified, and a communication connection between the electronic device and the electronic billboard is built. Information of the identified advertisement is obtained from the electronic billboard through the communication connection. The obtained formation of the advertisement is broadcasted on the electronic device.

### BACKGROUND

1. Technical Field

The embodiments of the present disclosure relate to an electronic device and method for broadcasting advertisements on the electronic device.

2. Description of Related Art

Electronic billboards are more widely used in broadcasting advertisements. However, the electronic billboards may not be suitable for voice broadcasts, which can create noise in public places. In addition, each advertisement may be displayed too quickly on the electronic billboards, thus, until the advertisement is once more displayed on the electronic billboards, some details of the advertisement may be missed.

### BRIEF DESCRIPTION OF THE DRAWINGS

FIG. 1 is a block diagram of one embodiment of an electronic device including an advertisement broadcast system.

FIG. 2 is a block diagram of one embodiment of function modules of the advertisement broadcast system in FIG. 1.

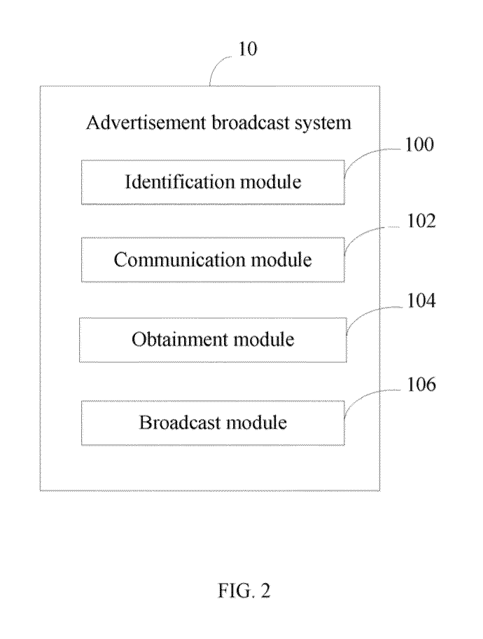

FIG. 3 is a flowchart of one embodiment of a method for broadcasting advertisements on the electronic device of FIG. 1.

FIG. 4 is an example of a database including relation between each quick response code or each NFC tag and information of each advertisement.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, flash memory, and hard disk drives.

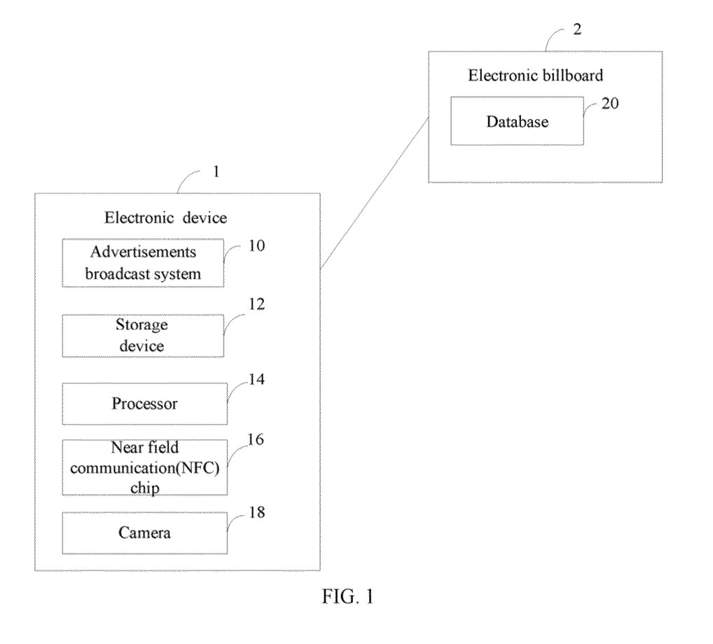

FIG. 1 is a block diagram of one embodiment of an electronic device 1 including an advertisement broadcast system 10. The electronic device 1 comprises a storage device 12, at least one processor 14, a near field communication(NFC) chip 16, and a camera 18. In the embodiment, the electronic device 1 may be a personal computer, a notebook computer, a cellular phone, a master production scheduler (MPS), or a personal digital assistant (PDA), for example. The electronic device 1 communicates with an electronic billboard 2 by means of BLUETOOTH, WIFI, or other communication systems.

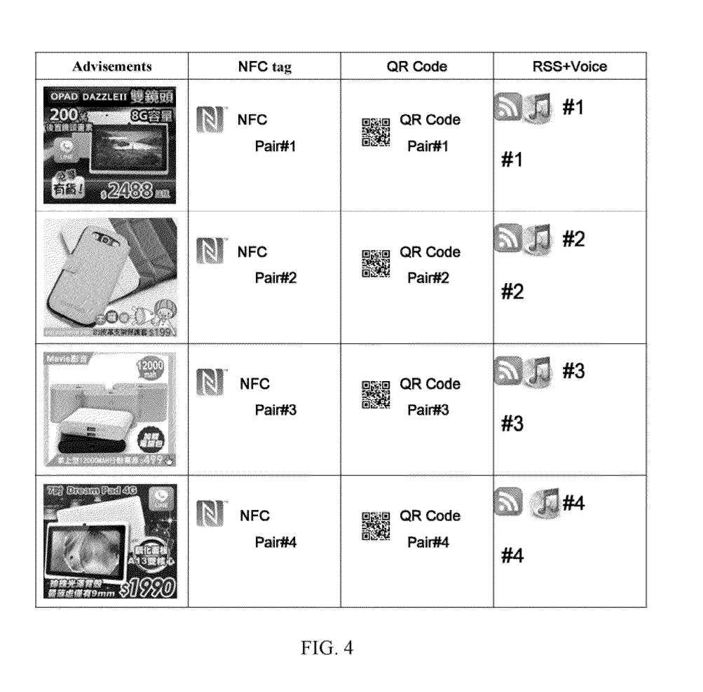

The electronic billboard 2 broadcasts advertisements one by one at time intervals, such as 3 seconds. The electronic billboard 2 comprises quick response codes(quick response code is an optically machine-readable label that is attached to an item and that records information related to that item. The information encoded by a QR code may be made up of four standardized types of data or, through supported extensions, virtually any type of data.) or near field communication (NFC)(NFC is a set of standards for smartphones and similar devices to establish radio communication with each other by touching them together or bringing them into proximity, usually no more than a few inches.) tags corresponding to each advisement. The quick response codes and the NFC tags may be on a lower part of the electronic billboard 2. Each quick response code or each NFC tag differentiates one advertisement from the other advertisements broadcasted on the electronic billboard 2, and is dynamically updated to correspond with an advertisement currently being broadcasted on the electronic billboard 2. As shown in FIG. 4, the electronic billboard 2 further comprises a database 20 including a relationship between each quick response code or each NFC tag and information of each advertisement. The information may comprise really simple syndication (RSS) and voice information of each advertisement.

In one embodiment, the storage device 12 (non-transitory storage device) may be an internal storage system, such as a random access memory (RAM) for the temporary storage of information, and/or a read only memory (ROM) for the permanent storage of information. In some embodiments, the storage device 12 may be an external storage system, such as an external hard disk, a storage card, or a data storage medium.

The at least one processor 14 may include a processor unit, a microprocessor, an application-specific integrated circuit, and a field programmable gate array, for example.

The NFC chip 16 identifies an NFC tag on the electronic billboard 2 when the electronic device 1 is close to the NFC tag at a certain distance (for example, 10 cm). The camera 18 then captures an image of the electronic billboard 2.

In one embodiment, the advisement broadcast system 10 includes a plurality of function modules which include computerized codes or instructions that can be stored in the storage device 12 and executed by the at least one processor 14 to provide a method for broadcasting advisements.

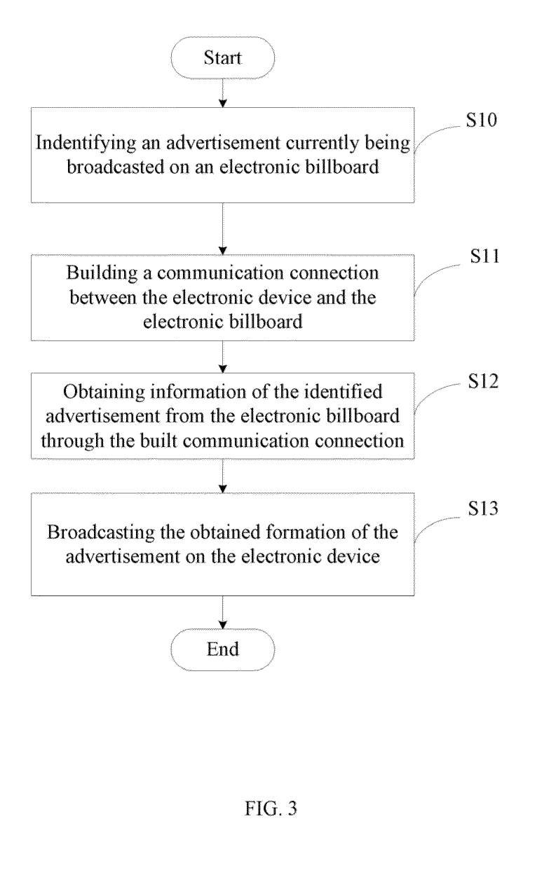

In one embodiment, the advisement broadcast system 10 may include an identification module 100, a communication module 102, an obtainment module 104, and a broadcast module 106. The modules may comprise computerized codes in the form of one or more programs that are stored in the storage device 12 and executed by the at least one processor 14 to provide functions for implementing the electronic billboard information obtainment system 10. The functions of the function modules are illustrated in FIG. 3 and described below.

FIG. 3 illustrates a flowchart of one embodiment of a method for broadcasting advisements on the electronic device 1 of FIG. 1. Depending on the embodiment, additional steps may be added, others removed, and the ordering of the steps may be changed.

In step S10, the identification module 100 identifies an advertisement currently being broadcasted on the electronic billboard 2. In the embodiment, the advertisement currently being broadcasted on the electronic billboard 2 may be identified by means of controlling the camera 18 to capture an image of the electronic billboard 2 and identifying a quick response code from the captured image. In the embodiment, the advertisement currently broadcasted on the electronic billboard 2 can also be identified by means of controlling the NFC chip 16 to identify a NFC tag currently on the electronic billboard 2.

In step S11, the communication module 102 builds a communication connection between the electronic device 1 and the electronic billboard 2. In the embodiment, the communication connection between the electronic device 1 and the electronic billboard 2 may be built by means of BLUETOOTH or WIFI.

In step S12, the obtainment module 104 obtains information of the identified advertisement from the electronic billboard 2 through the communication connection. In the embodiment, the information of the identified advertisement may be obtained by means of obtaining the information corresponding to the identified quick response code from the database 20 of the electronic billboard 2. In the embodiment, the information of the identified advertisement is also obtained by means of obtaining the information corresponding to the identified NFC tag from the database 20 of the electronic billboard 2.

In step S13, the broadcast module 106 broadcasts the obtained information of the advertisement on the electronic device 1 through a predefined application program. In the embodiment, the predefined application program may be a video playing software. In the embodiment, if the predefined application program is not installed in the electronic device 1, the broadcast module 106 may control the electronic device 1 to connect to the Internet to download the predefined application program and install the predefined application program in the electronic device 1.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
at least one processor; and
a storage device storing a computer program including instructions that, which executed by the at least one embedded controller, causes the at least one embedded controller to:
indentify an advertisement currently being broadcasted on an electronic billboard;
build a communication connection between the electronic device and the electronic billboard;
obtain information of the identified advertisement from the electronic billboard through the communication connection; and
broadcast the obtained formation of the advertisement on the electronic device.

2. The electronic device according to claim 1, wherein the advertisement currently being broadcasted on the electronic billboard is identified by controlling a camera of the electronic device to capture an image of the electronic billboard and identifying a quick response code of the electronic billboard from the captured image.

3. The electronic device according to claim 2, wherein the information of the identified advertisement is obtained by obtaining the information corresponding to the identified quick response code from a database of the electronic billboard.

4. The electronic device according to claim 1, wherein the advertisement currently broadcasted on the electronic billboard is identified by controlling a near field communication (NFC) chip of the electronic device to identify a NFC tag currently on the electronic billboard.

5. The electronic device according to claim 4, wherein the information of the identified advertisement is obtained by obtaining the information corresponding to the identified NFC tag from a database of the electronic billboard.

6. A method for broadcasting advertisements on an electronic device, the method comprising:
identifying an advertisement currently being broadcasted on an electronic billboard;
building a communication connection between the electronic device and the electronic billboard;
obtaining information of the identified advertisement from the electronic billboard through the communication connection; and
broadcasting the obtained formation of the advertisement on the electronic device.

7. The method according to claim 6, wherein the advertisement currently being broadcasted on the electronic billboard is identified by controlling a camera of the electronic device to capture an image of the electronic billboard and identifying a quick response code of the electronic billboard from the captured image.

8. The method according to claim 7, wherein the information of the identified advertisement is obtained by obtaining the information corresponding to the identified quick response code from a database of the electronic billboard.

9. The method according to claim 6, wherein the advertisement currently being broadcasted on the electronic billboard is identified by controlling a near field communication (NFC) chip of the electronic device to identify a NFC tag currently on the electronic billboard.

10. The method according to claim 9, wherein the information of the identified advertisement is obtained by obtaining the information corresponding to the identified NFC tag from a database of the electronic billboard.

11. A non-transitory computer-readable storage medium having stored thereon instructions being executed by a processor of an electronic device, causes the processor to perform a method for broadcasting advertisements on the electronic device, the method comprising:
indentifying an advertisement currently being broadcasted on an electronic billboard;
building a communication connection between the electronic device and the electronic billboard;
obtaining information of the identified advertisement from the electronic billboard through the communication connection; and
broadcasting the obtained formation of the advertisement on the electronic device.

12. The storage medium according to claim 11, wherein the advertisement currently being broadcasted on the electronic billboard is identified by controlling a camera of the electronic device to capture an image of the electronic billboard and identifying a quick response code of the electronic billboard from the captured image.

13. The storage medium according to claim 12, wherein the information of the identified advertisement is obtained by obtaining the information corresponding to the identified quick response code from a database of the electronic billboard.

14. The storage medium according to claim 11, wherein the advertisement currently being broadcasted on the electronic billboard is identified by controlling a near field communication (NFC) chip of the electronic device to identify a NFC tag currently on the electronic billboard.

15. The storage medium according to claim 14, wherein the information of the identified advertisement is obtained by obtaining the information corresponding to the identified NFC tag from a database of the electronic billboard.
